(19) United States
(12) Patent Application Publication
(10) Pub. No.: US 2011/0226071 A1
(43) Pub. Date: Sep. 22, 2011

(54) CARTRIDGE

(76) Inventors: Taeyoon LEE, Seoul (KR); Keumcheol Kwak, Seoul (KR); Jungsun Han, Seoul (KR); Jitae Kim, Seoul (KR); Gueisam Lim, Seoul (KR); Yeonjae Kang, Seoul (KR)

(21) Appl. No.: 13/048,560

(22) Filed: Mar. 15, 2011

(30) Foreign Application Priority Data
Mar. 19, 2010 (KR) 10-2010-0024732
May 6, 2010 (KR) 10-2010-0042325

(51) Int. Cl. G01N 1/20

(52) U.S. Cl. 73/863.43

(57) ABSTRACT

A cartridge is provided. The cartridge amplifies a quantity of a generating signal and increases storability thereof by widening a surface area that fixes a detection material for detecting an index material.

Priority to KR application number 10-2010-0024732 filed on Mar. 19, 2010 and 10-2010-0042325 filed on May 6, 2010 the entire disclosure of which is incorporated by reference herein, is claimed.

### BACKGROUND

1. Field

This document relates to a cartridge for a spot inspection, and more particularly, to a cartridge having improved storability and accuracy of a spot inspection.

2. Related Art

A biochip is a typical example in which new nanotechnology (NT), biotechnology (BT), and informationtechnology (IT) are converged. The biochip is a technology in which a material technology such as NT, BT, which is an application field and contents of the technology, and IT technology that analyzes a result or a large amount of results are converged.

The biochip is formed by high-density microarraying various kinds of detection materials, for example, a biomaterial at a surface of a solid-phase support body of a unit area, and is classified into various kinds of chips such as a DNA chip, a protein chip, a cell chip, and a neuron chip according to a biomaterial for attaching to a surface thereof. Further, the biochip has been developed into a lab-on-a-chip (LOC) by converging with microfluidic technology.

A research for improving accuracy of an inspection and storability of the biochip through the biochip has been performed. Further, a research for increasing a reaction ratio of the biochip has been performed.

### SUMMARY

An aspect of this document is to amplify a signal occurring from a sample of a small quantity.

Another aspect of this document is to increase reactivity of a measurement target.

Another aspect of this document is to increase storability of a cartridge.

Another aspect of this document is to stably fix or position a sol-gel composition to a cartridge.

Another aspect of this document is to easily transfer electrons occurring as an inspection result.

In an aspect, a cartridge comprises: a channel configured to provide a flow passage of a sample; an electrode positioned at a specific segment of the channel; a fixing structure positioned at the specific segment; and a detection material coupled to a surface of the fixing structure to detect an index material, wherein a surface area of the fixing structure at the specific segment is larger than that of the electrode at the specific segment.

In another aspect, a cartridge comprises: a channel configured to provide a flow passage of a sample; an electrode positioned at one side of the channel; a hydrophobic membrane positioned at a flow passage on the electrode; and a detection material impregnated to the hydrophobic membrane to detect an index material.

In another aspect, a cartridge comprises: an electrode; and a sol-gel composition comprising a detection material provided on the electrode to detect an index material.

### BRIEF DESCRIPTION OF THE DRAWINGS

The implementation of this document will be described in detail with reference to the following drawings in which like numerals refer to like elements.

FIG. 1 is a block diagram illustrating configurations of a cartridge and a reader that can be connected to the cartridge according to an implementation of this document;

FIG. 2 is a diagram illustrating a cartridge according to an implementation of this document;

FIGS. 3 and 4 are conceptual diagrams illustrating an antibody-antigen reaction of this document;

FIGS. 5 to 8 are diagrams illustrating a detection unit according to an implementation of this document;

FIG. 9 is a flowchart illustrating a process of manufacturing a detection unit according to an implementation of this document;

FIGS. 10 to 12 are diagrams illustrating a filter portion according to an implementation of this document;

FIG. 13 is a flowchart illustrating a process of measuring an index material according to an implementation of this document;

FIG. 14 is a diagram illustrating a detection unit according to another implementation of this document;

FIG. 15 is a flowchart illustrating a method of manufacturing a detection unit according to another implementation of this document;

FIGS. 16 to 19 are diagrams illustrating a sol-gel composition according to an implementation of this document;

FIGS. 20 to 22 are diagrams illustrating a detection unit according to an implementation of this document;

FIGS. 23 to 25 are diagrams illustrating a detection unit according to another implementation of this document;

FIGS. 26 to 28 are diagrams illustrating a detection unit according to another implementation of this document;

FIG. 29 is a flowchart illustrating a method of controlling a sol-gel composition according to an implementation of this document;

FIGS. 30 and 31 are diagrams illustrating movement of a sol-gel composition according to an implementation of this document; and

FIG. 32 is an enlarged view illustrating a sol-gel composition.

### DETAILED DESCRIPTION

These and other objects of this document will become more readily apparent from the detailed description with reference to the attached drawings. However, it should be understood that the detailed description and specific examples, while indicating implementations of this document, are given by way of illustration only, since various changes and modifications within the spirit and scope of this document will become apparent to those skilled in the art from this detailed description. Like reference numerals designate like elements throughout the specification. Further, detailed descriptions of well-known functions and structures incorporated herein may be omitted to avoid obscuring the subject matter of this document. Further, numerals (for example, a first and a second) using when describing this specification are an identification symbol for distinguishing one element from other elements. A term used in this specification is used for describing a particular implementation, not for limiting a range of this document. Further, elements according to an implementation of this document are selectively combined and used.

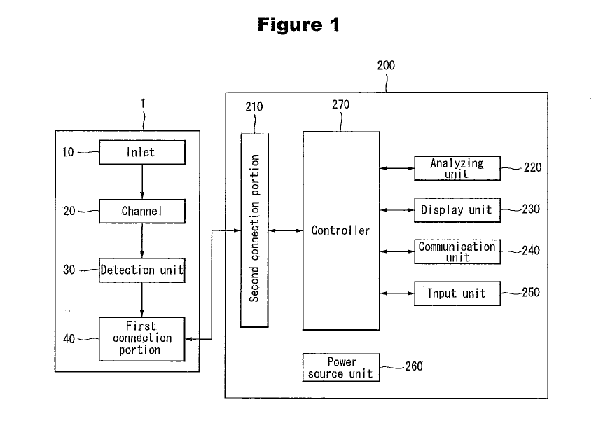

FIG. 1 is a block diagram illustrating configurations of a cartridge and a reader that can be connected to the cartridge according to an implementation of this document.

Referring to FIG. 1, the cartridge according to an implementation of this document will be described.

The cartridge 1 comprises an inlet 10, a channel 20, a detection unit 30, and a first connection portion 40. Further, the cartridge 1 is used for point of care testing (POCT) and may be referred to as a biochip or a medical sensor. Further, the cartridge 1 may detect a contaminating material.

The cartridge 1 generates a predetermined signal corresponding to a numerical value of a specific chemical and/or biochemical material (hereinafter, referred to as an ‘index material’) comprised in a sample injected into the cartridge 1. For example, the cartridge 1 may generate a useful signal that can recognize, such as an optical signal and/or an electrical signal corresponding to a quantity or a density of the index material.

Hereinafter, the sample comprises a blood sample. The index material may comprise, for example, blood sugar, cholesterol, a material related to blood sugar and cholesterol, pathogenic bacteria, and virus. Further, the index material comprises a material of other fields as well as a bio field. For example, the index material may comprise a contaminating material.

The inlet 10 is an inlet of the channel 20. The inlet 10 is used for injecting the sample. The inlet 10 has a predetermined sectional area in order to enable easy injection of the sample. The inlet 10 is communicated with the channel 20.

The channel 20 is connected to the inlet 10. The channel 20 provides a flow path for moving a sample injected into the inlet 10. The channel 20 is provided to move the sample to the detection unit 30. The sample is moved using a capillary force, a pressure, and a centrifugal force as power within the channel 20.

The channel 20 may be, for example, a microfluidic channel. The microfluidic channel is a channel for flowing a sample by a capillary.

Although not shown in the drawings, the cartridge 1 comprises a predetermined filter structure that selectively passes through only an index material comprised in the sample, as needed. The index material may be a target material to measure using, for example, the cartridge 1. The filter structure may be disposed on a flow path of the channel 20. For example, the filter structure may be integrally formed with the inlet 10 and disposed between the inlet 10 and the channel 20.

The detection unit 30 is connected to the channel 20. The sample is injected into the detection unit 30 through the channel 20. The detection unit 30 generates a predetermined signal changing according to a numerical value of an index material comprised in the sample. The predetermined signal comprises an optical signal and/or an electric signal.

The detection unit 30 generates an optical signal and/or an electrical signal by processing an index material with a known method.

A method of generating the optical signal and/or the electrical signal is described as follows.

The optical method uses an optical characteristic of the processed sample. The optical method comprises colorimetry, which is an analyzing method of comparing a color tone of a test liquid with that of a standard liquid and of quantitatively analyzing the color tone, fluorescence that measures intrinsic light emitted from any kind of material when any kind of material receives light, electron ray, X-ray, and radiation ray, and chemiluminescence that measures light generated as a result of a chemical reaction.

The electrical method uses an electrical characteristic of a processed sample. For example, the electrical method may comprise a process of generating a current and/or a voltage from the processed sample.

Hereinafter, a detailed configuration of the detection unit 30 will be described.

The first connection portion 40 is connected to a second connection portion 210 of the reader 200. The first connection portion 40 receives a predetermined signal from the reader 200 and transfers the predetermined signal to the cartridge 1, and transfers a predetermined signal generating in the cartridge 1 to the reader 200.

Hereinafter, the reader 200 connected to the cartridge 1 will be described with reference to FIG. 1.

The reader 200 transfers a predetermined signal to the cartridge 1 and receives, processes, and analyzes a signal generated in the cartridge 1. A predetermined signal transferred to the cartridge 1 and/or a signal generated in the cartridge 1 may be an electrical signal.

The reader 200 comprises the second connection portion 210, an analyzing unit 220, a display unit 230, a communication unit 240, an input unit 250, a power source unit 260, and a controller 270.

The second connection portion 210 transfers a predetermined signal to the cartridge 1 or receives a signal generated in the cartridge 1.

The analyzing unit 220 receives and analyzes a signal generated in the cartridge 1 through the second connection portion 210. For example, the analyzing unit 220 may make a quantity or a density of an index material comprised in the sample in a numerical value using the received signal.

The display unit 230 displays an analyzed result, for example, a numerical value of the index material.

The communication unit 240 provides a function of allowing the reader 200 to communicate with an external device. For example, the reader 200 may receive various information through the communication unit 240 and transmit a result analyzed in the analyzing unit 220. The communication unit 240 comprises a mobile communication module, wired and wireless Internet modules, and a short range communication module.

The input unit 250 is used for inputting various inputs of a user to the reader 200. For example, the input unit 250 may be embodied with a keypad, a keyboard, a mouse, a touch screen, and a touch pad.

The power source unit 260 supplies necessary power to the cartridge 1 and the reader 200.

The controller 270 controls elements of the reader 200 and controls general operations of the reader 200.

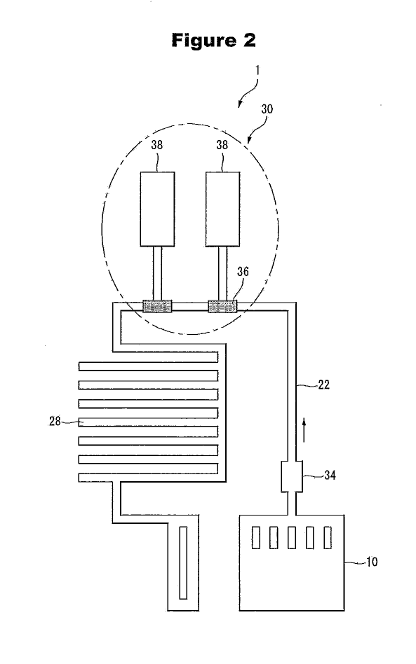

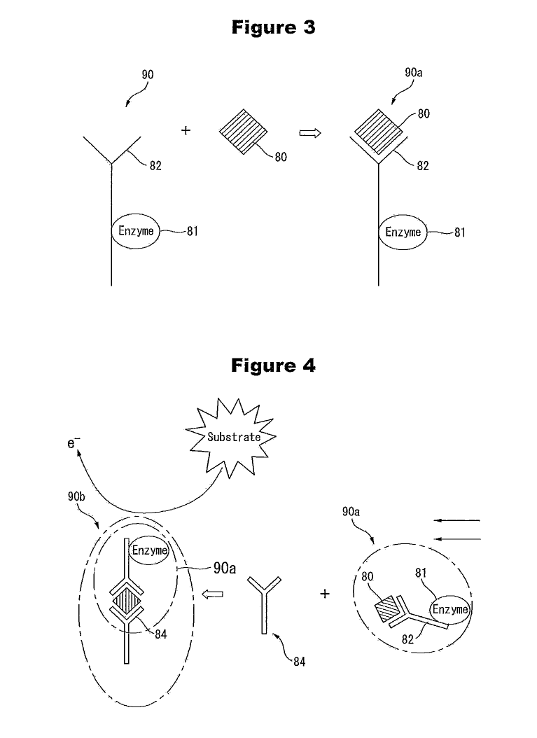

FIG. 2 is a diagram illustrating a cartridge according to an implementation of this document, and FIGS. 3 and 4 are conceptual diagrams illustrating an antibody-antigen reaction of this document.

The cartridge 1 comprises the inlet 10, the channel 20, the detection unit 30, and a storage 34.

The inlet 10 comprises a filter pad, for example, a filter (not shown) while providing a connection passage with a channel. The filter may filter a blood corpuscle of a blood and move only a serum to a channel. That is, when an index material to detect mainly exists within a serum, the inlet 10 can previously remove a blood corpuscle that may disturb measurement through the filter.

The channel 20 comprises channels 22 and 28 according to a path. For example, the channel 22 may connect the inlet 10 and the detection unit 30. The channel 28 provides a function of absorbing and storing a sample and/or a reagent flowing in the channel.

The storage 34 stores an antibody 90 (see FIG. 3) in which an enzyme is bonded. An antibody 82 (see FIG. 3) is coupled to an index material 80 (see FIG. 3) comprised in the sample. An enzyme 81 provides a function of generating an electron when an electrical signal is generated in the detection unit 30. That is, the storage 34 provides a material that can generate an electrical signal corresponding to a quantity of an index material.

A reaction in the storage 34 is described with reference to FIG. 3 as follows.

The storage 34 stores the Y-shaped antibody 82 in which the enzyme 81 is bonded at one end thereof. Hereinafter, a compound in which the enzyme 81 and the antibody 82 are coupled is referred to as an enzyme binding antibody 90. When a sample comprising an index material enters the storage 34 through the inlet 10, the enzyme binding antibody 90 and the index material 80 comprised in the sample are coupled. In this case, the index material 80 comprised in the sample couples with the enzyme binding antibody 90 by operating as an antigen, thereby generating a first coupling material 90a.

In other words, the index material 80 comprised in the sample for flowing in a channel between the inlet 10 and the enzyme glue storage 34 is coupled with the enzyme binding antibody 90 through an antigen-antibody reaction at the storage 34. Other materials comprised in the sample flow.

The detection unit 30 comprises an electrode 36 and an electrode connection portion 38.

The electrode 36 provides a function of generating a current corresponding to a numerical value of an index material comprised in the sample. The electrode connection portion 38 provides a function of applying a voltage to the electrode 36.

Referring to FIG. 4, a function of the detection unit 30 is described in detail. Further, the following description describes an electrochemical method as an example. The detection unit 30 comprises a detection material 84 (see FIG. 4), for example, a fixing antibody 84. The detection material comprises a material for detecting an index material. The enzyme binding antibody 90, i.e., the first coupling material 90a coupled with the index material 80 by an antigen-antibody reaction at the storage 34 is comprised within a sample for flowing an upper surface of the electrode 36. In this case, the index material 80 of the first coupling material 90a secondarily causes an antigen-antibody reaction with the fixing antibody 84. Therefore, all the fixing antibody 84, the index material 80, and the enzyme binding antibody 90 are coupled, thereby generating a second coupling material 90b.

The controller 270 injects a detection sample comprising a substrate and/or a washing solution to the second coupling material 90b. In this case, the detection sample and a liquid reagent are a synonym. The substrate reacts with the enzyme 81. The substrate may be, for example, p-aminophenyl phosphate (p-APP). p-APP reacting with the enzyme 81 can be changed to p-aminophenol (p-AP). When an oxidation voltage is applied to the P-AP, electrons are emitted. The oxidation voltage is provided from the reader 200 through the first and second connection portions 40 and 210.

Accordingly, an electrical signal occurs by an electron (e-) emitted by an oxidation reaction. For example, a current may occur by the electron (e-) emitted between predetermined electrodes 36. By measuring intensity of such current, a quantity and/or a density of the index material 80 comprised in the sample are/is analyzed. The electrical signal is transmitted to the reader 200, the current intensity is analyzed in the analyzing unit 220 of the reader 200.

That is, the number of enzymes 81 reacting with a substrate changes according to the number of the first coupling materials 90a coupled to the fixing antibody 84 and thus intensity of a generated current changes. Therefore, as current intensity changes according to the number of the index materials 80 comprised in the sample, a quantity and/or a density of the index materials 80 comprised in the sample are/is measured.

In an implementation described with reference to FIGS. 3 and 4, the first coupling material 90a in which the index material 80 and the enzyme binding antibody 90 are coupled is supplied to the detection unit 30.

Alternatively, the following implementation may be performed.

As shown in FIG. 4, the following implementation is equal to the foregoing implementation in that the detection unit 30 comprises the electrode 36 and the fixing antibody 84.

The following implementation is different from the foregoing implementation in that the index material 80 is provided to the detection unit 30 with uncoupled with the enzyme binding antibody 90 and thus the index material 80 can be coupled with the fixing antibody 84. Thereafter, the enzyme binding antibody 90 is provided to the detection unit 30, and the enzyme binding antibody 90 is coupled to the index material 80 coupled with the fixing antibody 84. A method of generating an electron by supplying a substrate is equal to a method of the foregoing implementation.

Hereinafter, a detection material will be described in detail, and a method of positioning a detection material at the detection unit 30 will be described in detail.

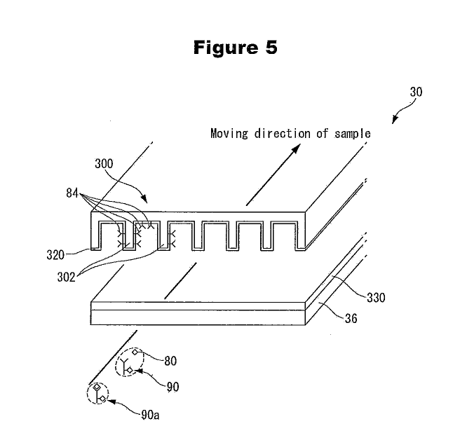

FIGS. 5 to 8 are diagrams illustrating a detection unit according to a first implementation of this document.

The detection unit 30 comprises a structure 300, an electrode 36, and a fixing antibody 84.

The detection unit 30 detects the index material 80 and generates an electrical signal corresponding to a quantity and/or a density of the index material 80.

As described above, the fixing antibody 84 is a material that can perform an antigen-antibody reaction with the index material 80. The fixing antibody 84 is coupled to one side of the detection unit 30, for example, one surface of the structure 300.

The structure 300 provides space for flowing the sample. The sample may be, for example, a blood. The structure 300 may be, for example, the channel 20. Further, the structure 300 may have, for example, a micro size. The structure 300 is formed with a known material having low reactivity with a sample in order to prevent non-specific coupling. The structure 300 may be referred to as a fixing structure.

The structure 300 may further comprise a plurality of posts 302. The post 302 provides a function of widening a surface area in which the fixing antibody 84 can be coupled. In other words, when a surface area of the electrode 36 is A within a specific segment, an opposite surface of the electrode 36 provides a surface area B larger than A by the post 302 within the same specific segment. The post 302 may be formed in various shapes other than a shape of the post 302 shown in FIG. 5.

The fixing antibody 84 is coupled to one side of the structure 300. That is, the fixing antibody 84 is coupled to the post 302 of the structure 300. The fixing antibody 84 is coupled to one side of the structure 300 and/or the post 302 through physical adsorption. The post 302 can widen an area in which the fixing antibody 84 can be coupled. Therefore, as the number of coupling individuals of the fixing antibody 84 increases, a signal generating by the index material can increase and thus reliability of measurement can be improved. That is, a signal to noise ratio (SNR) can be increased. The fixing antibody 84 may be coupled to one side of the electrode 36.

One side of the structure 300 is coated with a blocking material 320. For example, the inside of the structure 300 may be coated with bovine serum albumin (hereinafter, referred to as ‘BSA’) or casein.

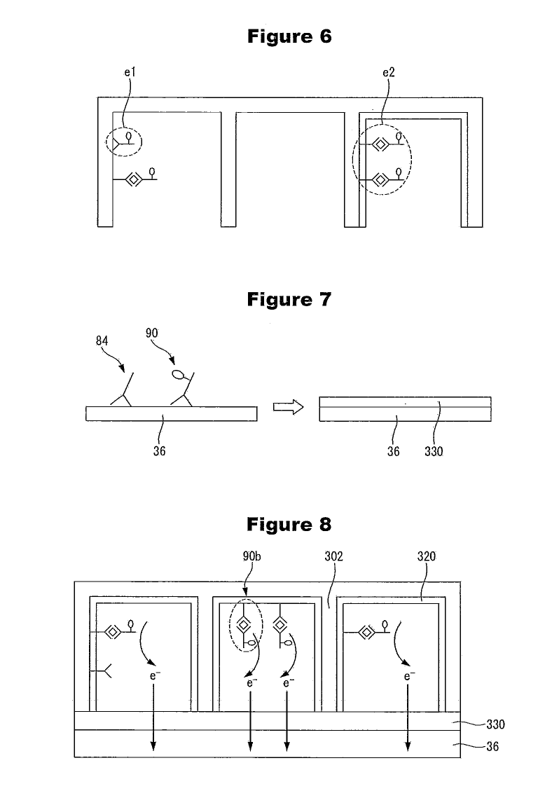

Referring to FIG. 6, the blocking material 320 is described in detail.

Referring to an e1 area shown in FIG. 6, it can be seen that the enzyme binding antibody 90 is coupled to the inside of the structure 300. The enzyme binding antibody 90 is coupled with the structure 300 in a state in which the second coupling material 90b is not generated, i.e., a state that is not coupled with the index material 80. In this case, an enzyme of the enzyme binding antibody 90 that is not coupled with the index material 80 generates an electron through a reaction with a substrate. In this case, an electric signal occurring in the enzyme binding antibody 90 that is not coupled with the index material 80 is a signal generating regardless of a numerical value of the index material 80 and thus may be an error induction signal, i.e., an error signal. In addition, other materials comprised in the sample are coupled to the structure 300 to generate an error signal. This is referred to as non-specific coupling. Therefore, coating for preventing a material that may cause an error signal from coupling with the structure 300 is necessary.

An e2 area shown in FIG. 6 illustrates that the structure 300 and/or the post 302 is coated with the blocking material 320. The blocking material 320 prevents non-specific coupling. Therefore, the blocking material 320 can prevent an error signal. The blocking material 320 may be a known material having low reactivity with a protein.

Referring again to FIG. 5, the electrode 36 provides a passage for moving electrons generating in the second coupling material 90b. In this case, it is necessary that an upper surface of the electrode 36 prevents non-specific coupling. Furthermore, the electrode 36 should allow electrons to pass through while preventing non-specific coupling. For this, the electrode 36 further comprises a surface treatment film 330.

Referring to the left side of FIG. 7, it can be seen that the enzyme binding antibody 90 is non-specifically coupled to the electrode 36.

Referring to the right side of FIG. 7, it can be seen that an upper surface of the electrode 36 is coated with the surface treatment film 330.

The surface treatment film 330 may be, for example, a monomer layer or a polymer layer. The surface treatment film 330 allows electrons generated in the second coupling material 90b to pass through the electrode 36 through an electron tunneling effect. That is, it is necessary that the surface treatment film 330 is formed in a thin film in order to generate an electron tunneling effect. The monomer layer may have a thickness of, for example, 1 to 2 nm. The polymer layer may have a thickness of, for example, 1 μm or less.

Further, the monomer layer and the polymer layer may have a hydrophilic property unfriendly with a protein.

A hydrophilic polymer layer may be, for example, hydrogel or polyvinyl alcohol. Because the polymer layer has a hydrophilic property, the polymer layer has a low protein coupling force. Therefore, the polymer layer can prevent an error signal induction material, which is a protein from non-specifically coupling with the surface treatment film 330.

FIG. 8 illustrates a coupling degree of the detection unit 30 according to a first implementation of this document.

An arrow of FIG. 5 illustrates a flow direction of a fluid. As described above, the index material 80 and the enzyme binding antibody 90 may be separately injected into the detection unit 30 or may be injected into the detection unit 30 in a form of the first coupling material 90a.

In two cases, as shown in FIG. 8, the index material 80 and the enzyme binding antibody 90 generate the second coupling material 90b by coupling with the fixing antibody 84.

As described above, by supplying a washing liquid and a substrate to the second coupling material 90b, electrons can be generated. The generated electrons a re moved to the electrode 36. For example, electrons may be moved in a direction of the electrode 36 by diffusing. Further, electrons reach the electrode 36 by passing through the surface treatment film 330 through an electron tunneling effect.

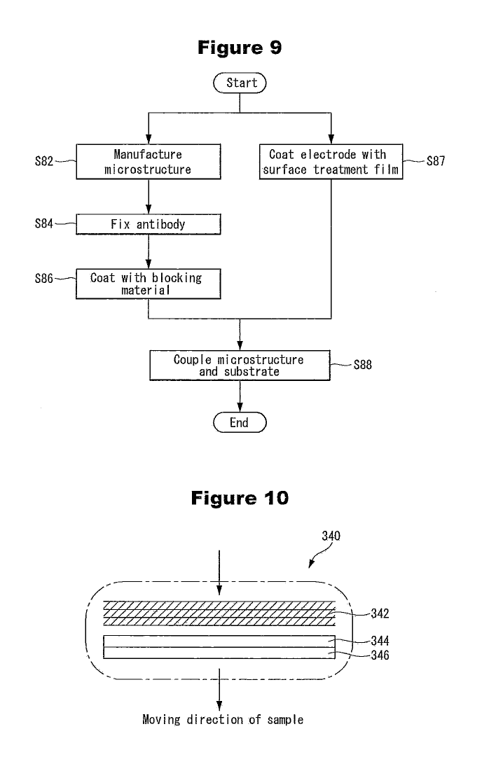

FIG. 9 is a flowchart illustrating a process of manufacturing a detection unit 30 according to a first implementation of this document

FIG. 9 is a flowchart comprising the above-described essential and random elements, and the detection unit 30 may be manufactured with only essential elements other than random elements according to determination of a person of ordinary skill in the art.

The structure is manufactured (S82). The structure may be, for example, a microchannel. Further, an inner diameter of the structure changes according to a driving force of a fluid. For example, when a driving force is a capillary force, an inner diameter of the structure should be narrowed to occur a capillary force.

Further, the structure comprises at least one post 302 at the inside thereof. A direction and a length of the post 302 can be easily changed by a person of ordinary skill in the art.

The fixing antibody 84 is fixed to the manufactured structure (S84). The fixing antibody 84 is fixed to the structure and the post 302 by, for example, physical adsorption.

One side of the structure and the post 302 is coated with the blocking material 320 (S86). As described above, the blocking material 320 prevents non-specific coupling.

The electrode 36 is coated with the surface treatment film 330 (S87). The surface treatment film 330 allows movement of electrons while preventing non-specific coupling.

The structure coated with the blocking material 320 and the electrode 36 coated with the surface treatment film 330 are coupled (S88). Further, the structure is coupled with the substrate comprising the electrode 36.

FIG. 10 illustrates a filter portion 340 according to an implementation of this document.

The cartridge 1 may further comprise the filter portion 340. As described above, the filter portion 340 filters an error signal generating material comprised in the sample. Therefore, the filter portion 340 can reduce a material that non-specifically couples to the detection unit 30 while reducing an error signal.

As shown in FIG. 10, the filter portion 340 comprises a mesh 342, a serum separation pad 344, and a separation film 346. An arrow shown in FIG. 10 shows a moving direction of a sample. That is, the sample is filtered while passing through the mesh 342, the serum separation pad 344, and the separation film 346.

The serum separation pad 344 provides a function of removing a red blood corpuscle comprised in the sample. That is, the serum separation pad 344 filters a red blood corpuscle that may generate an error signal before detection and thus removes an error signal.

The separation film 346 provides a function of removing other materials that disturb measurement. For example, other materials that disturb measurement may comprise ethylenediaminetetraacetic acid (EDTA).

The filter portion 340 is comprised in the cartridge 1 with two methods.

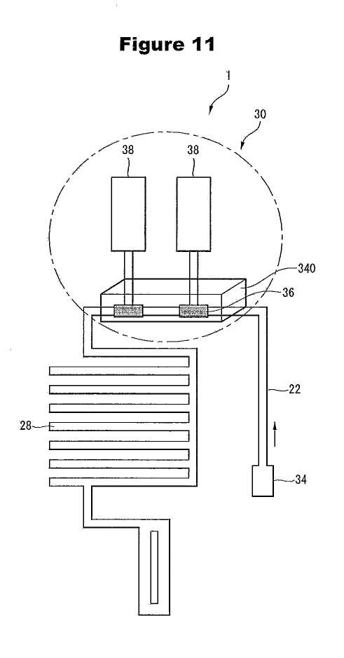

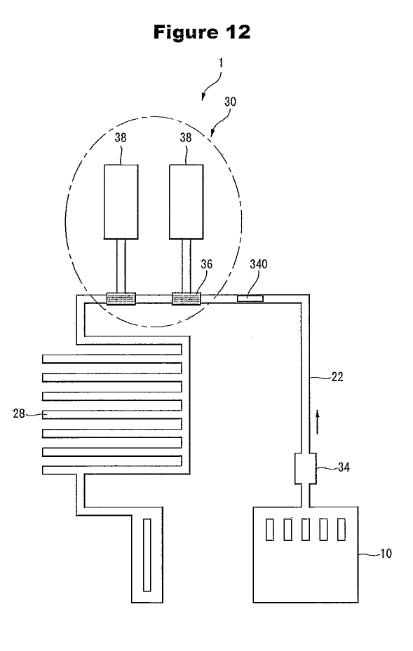

FIGS. 11 and 12 illustrate a position of the filter portion 340 according to an implementation of this document.

According to an implementation shown in FIG. 11, the inlet 10 is positioned at the filter portion 340.

Further, according to an implementation shown in FIG. 12, the filter portion 340 is positioned in a fluid moving direction within the cartridge 1. In this case, a driving force of a fluid may be a pressure difference.

Hereinafter, a method of operating the cartridge and the reader described in an implementation of FIGS. 1 and 2 will be described with reference to the detection unit according to an implementation of FIG. 5. When describing an operating method, a physical structure is not limited to the implementation shown by FIGS. 1, 2, and 5.

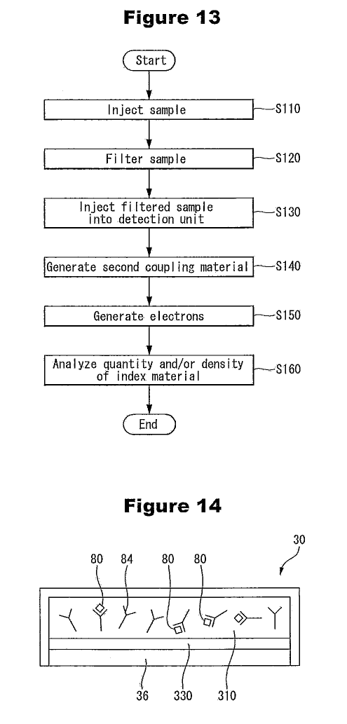

FIG. 13 is a flowchart illustrating a process of measuring an index material according to an implementation of this document.

A body fluid sample is injected through the inlet 10 (S110).

The injected sample is filtered through the filter portion (S120). For convenience of description, the filter portion is limited to the filter portion 340 according to an implementation of FIG. 11. The filter portion 340 removes a material that may generate an error signal from the sample.

The filtered sample is injected into the detection unit 30 (S130). An index material comprised within the sample is coupled through an antigen-antibody reaction with the fixing antibody 84 comprised in the detection unit 30.

The enzyme binding antibody 90 stored at the storage 34 is injected into the detection unit 30. The injected enzyme binding antibody 90 is coupled with the fixing antibody 84 to which the index material 80 is coupled, thereby forming the second coupling material 90b (S140). The blocking material 320 and the surface treatment film 330 prevent non-specific coupling that may generate an error signal. The controller 270 detects a predetermined time period in which the second coupling material 90b is formed.

The controller 270 generates electrons through the second coupling material 90b (S150). After a predetermined time period in which the second coupling material 90b is formed has elapsed, the controller 270 injects a washing liquid and a substrate into the detection unit 30. The second coupling material 90b generates electrons by reacting with a substrate. The generated electrons pass through the surface treatment film 330 and are moved to the electrode 36.

The controller 270 analyzes a quantity and/or a density of an index material (S160). That is, the controller 270 detects an electrical signal of the generated electron. The controller 270 determines a correlation between intensity of an electrical signal and a quantity and/or a density of an index material through the analyzing unit 220. Therefore, the controller 270 analyzes a quantity and/or a density of an index material through an electrical signal.

In this case, because the post 302 according to an implementation of this document increases a surface area in which the fixing antibody 84 can couple, the post 302 allows a large amount of second coupling materials 90b to form. Therefore, the post 302 provides a function of amplifying a signal.

FIG. 14 is a diagram illustrating a detection unit according to a second implementation of this document.

The detection unit 30 comprises a hydrophobic membrane 310. A description of the same configuration as a configuration, for example, the surface treatment film 330 and the electrode 36 according to an implementation of FIG. 5 may be omitted. The hydrophobic membrane 310 may be referred to as a film and a membrane.

The hydrophobic membrane 310 may be, for example, polyvinylidene fluoride (hereinafter, PVDF). The fixing antibody 84 may be fixed to a surface and the inside of the hydrophobic membrane 310. In this case, the fixing antibody 84 is coupled through a covalent bond, for example, silane, and a phosphate bond. Further, as the membrane has a hydrophobic property, a fixing force of the fixing antibody 84 can be increased because a hydrophobic property is higher than a hydrophilic property in a binding force with protein.

The hydrophobic membrane 310 can be coupled regardless of a direction of the fixing antibody 84 and the index material 80. That is, the fixing antibody 84 can be coupled in a random direction to the hydrophobic membrane 310, and the index material 80 can be coupled to the fixing antibody 84 of a random direction. Therefore, the hydrophobic membrane 310 can collect many fixing antibodies 84 and thus a signal can be amplified even in a low density.

Although not shown in the drawings, as the hydrophobic membrane 310 is coated with the blocking material 320, the hydrophobic membrane 310 can prevent non-specific coupling.

Further, the hydrophobic membrane 310 may be changed to a hydrophilic membrane. When coupling the fixing antibody 84, the hydrophobic membrane 310 increases a coupling force and thus the hydrophobic membrane 310 is preferable. However, even after the fixing antibody 84 is coupled, when the membrane sustains a hydrophobic property, the index material 80 and the enzyme binding antibody 90, which are a protein are coupled to the hydrophobic membrane 310 and thus non-specific coupling may occur. In order to prevent this, it is preferable that the hydrophobic membrane 310 is changed to a hydrophilic membrane, which is unfriendly with a protein.

Therefore, after the fixing antibody 84 is coupled to the hydrophobic membrane 310, by coating an NAS polymer to the hydrophobic membrane 310, a hydrophobic property of the hydrophobic membrane 310 is reduced or the hydrophobic membrane 310 may have a hydrophilic property. The NAS polymer is formed with three monomers. A first monomer is coupled with the hydrophobic membrane 310, a second monomer provides poly ethylene glycol (PEG) having a hydrophilic property, and a third monomer provides a functional group that can couple with the fixing antibody 84. That is, the hydrophobic membrane 310 can provide a hydrophilic property through PEG.

Further, the hydrophobic membrane 310 may have porosity. Therefore, because the sample can easily pass through the hydrophobic membrane 310, the second coupling material 90b can be easily generated.

The detection unit according to an implementation shown in FIG. 14 operates with an operation method of an order shown in FIG. 13.

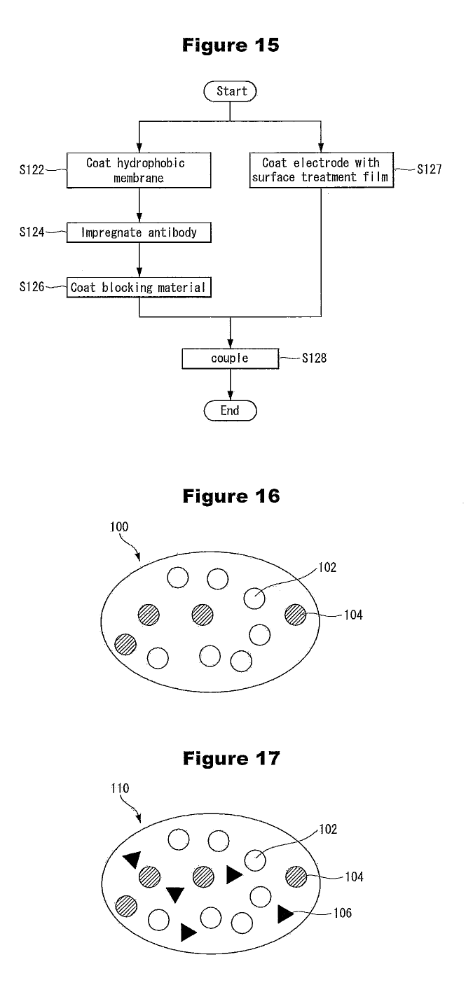

FIG. 15 is a flowchart illustrating a method of manufacturing a detection unit according to another implementation of this document.

FIG. 15 is a flowchart illustrating a process of manufacturing the detection unit according to an implementation of FIG. 14. When describing this flowchart, a description of the same step as that of the implementation of FIG. 9 will be omitted.

The channel 20 is coated with a hydrophobic membrane (S122).

The fixing antibody 84 is impregnated to the hydrophobic membrane (S124).

In order to prevent non-specific coupling, the hydrophobic membrane is coated with a blocking material (S126).

The electrode 36 is coated with the surface treatment film 330 (3127).

The structure 100 coated with the blocking material 320 and the electrode 36 coated with the surface treatment film 330 are coupled (S128).

Although not shown, an NAS polymer may be additionally coated.

Hereinafter, a method of fixing a detection material, for example, a fixing antibody 84 to the detection unit 30 using a sol-gel composition according to an implementation of this document will be described in detail.

FIGS. 16 to 19 are diagrams illustrating a sol-gel composition according to an implementation of this document.

As described above, a detection material comprises a fixing antibody for detecting an index material. In this case, the detection material is comprised in a sol-gel composition and is provided.

A first sol-gel composition 100 shown in FIG. 16 comprises a detection material 104. That is, the detection material 104 is collected within a gel, which is a three-dimensional structure and is formed in a capsule.

For a better understanding, a sol-gel reaction is described in detail as follows.

When colloid particles of several tens or several hundreds mm obtained by hydrolysis or dehydration condensation disperse silica microparticles obtained in flame hydrolysis of sol dispersed in a liquid to the liquid, liquidity of sol is damaged by aggregation or coagulation of the colloid particles in the sol and thus a gel of a porous body is obtained.

Further, a sol-gel process is used for forming a coupling network through a mild process instead of chemically attaching biomolecules to an inorganic material and for fixing biomolecules within the coupling network with a method other than a covalent bond.

The sol-gel structure is manufactured using, for example, a silicate monomer and a buffer solution.

The silicate monomer may be, for example, tetramethyl orthosilicate (TMOS), tetraethyl orthosilicate (TEOS), methyltrimethoxysilane (MTMOS), ethyltriethoxysilane, (ETrEOS), trimethoxysilane (TMS), methyltrimethoxysilicate (MTMS), and 3-aminopropyl trimethoxysilicate.

Further, by mixing particles of various sizes to a sol-gel structure, a size of an air gap of the sol-gel structure can be adjusted. For example, a size of an air gap may be adjusted using polyglyceryl silicate (PGS).

A collecting degree of the detection material 104 is adjusted according to a size of the air gap. That is, when a detection material has a large size, a size of an air gap increases, and when a detection material has a small size, a size of an air gap decreases. Further, the air gap is formed to have a size that allows an index material to easily penetrate into a sol-gel composition.

Further, by impregnating the detection material 104 to a manufacturing sol composition or a completed sol composition, the first sol-gel composition 100 is obtained.

An identification numeral 102 indicates a silicate monomer.

The sol-gel composition has various sizes. For example, the sol-gel composition may be formed in a nano size or a micro size in consideration of a size of a channel and a size of a spot.

A sol-gel composition is formed in a particle by various methods. For example, the sol-gel composition may be formed in a particle by manufacturing a mold of a sol state, coating a sol composition at the mold, then forming the sol composition in gel, and removing the mold. Further, droplets of a sol state are sprayed on a flat panel in which a surface treatment is performed, are formed in a gel, are separated from a surface, and are formed in particles.

The sol-gel composition collects a plurality of detection materials 104, for example, a fixing antibody 84. Therefore, the sol-gel composition allows a plurality of detection materials, i.e., a reaction individual to react with an index material.

Referring to FIG. 17, a second sol-gel composition 110 comprises a detection material 104 and a gold particle 106.

The gold particle 106 is an example, and the second sol-gel composition 110 comprises a high electrical conductive particle.

The gold particle 106 is prepared in a size that can be collected in an air gap of a sol-gel structure. Further, the gold particle 106 is impregnated to a manufacturing sol composition or a completed sol composition, thereby forming a second sol-gel composition 110.

The gold particle 106 provides a function of transferring electrons generated in the second sol-gel composition 110 to the electrode. That is, electrons, which are an electrical signal generating within the sol-gel composition are transferred to the electrode through the gold particle. In this case, because the gold particles have high electrical conductivity, the gold particles transfer generated electrons to the electrode, thereby preventing damage of electrons.

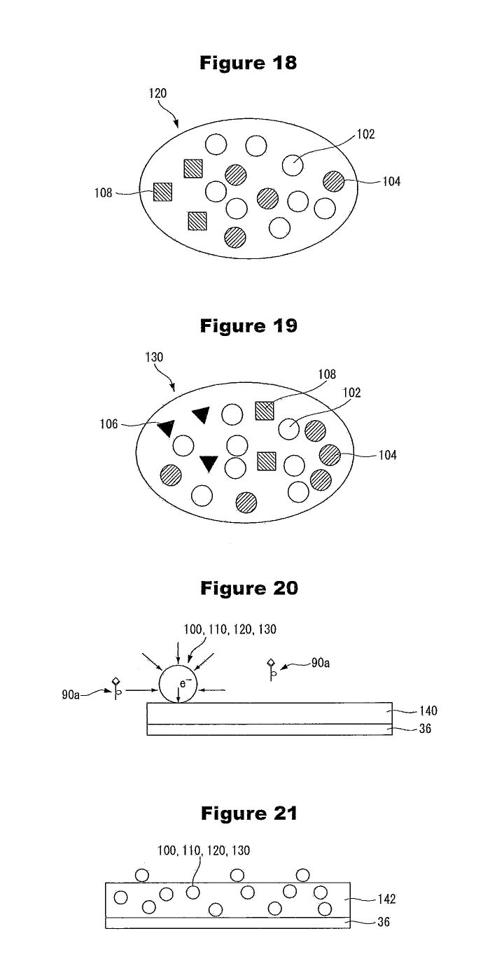

Referring to FIG. 18, a third sol-gel composition 120 comprises a detection material 104 and a magnetic material 108.

The magnetic material 108 is prepared in a size that can be collected in an air gap of a sol-gel structure. Further, the magnetic material 108 is impregnated to a manufacturing sol composition or a completed sol composition, thereby forming a third sol-gel composition 120.

The magnetic material 108 provides a function that can control a position of the third sol-gel composition 120 by magnetism. That is, as the magnetic material 108 is comprised in the sol-gel structure, the third sol-gel composition 120 is moved by a magnetic force of the outside.

For example, when attraction is applied from the outside, the third sol-gel composition 120 is taken away by the magnetic material 108 comprised in the third sol-gel composition 120. Further, for example, when repulsion is applied from the outside, the third sol-gel composition 120 advances in an opposite direction by the magnetic material 108 comprised in the third sol-gel composition 120.

The magnetic material 108 can use a known material.

Referring to FIG. 19, a fourth sol-gel composition 130 comprises a detection material 104, a gold particle 106, and the magnetic material 108.

The fourth sol-gel composition 130 provides a function and operational effect of the above-described detection material 104, gold particle 106, and magnetic material 108.

Hereinafter, a method of positioning the sol-gel compositions 100 to 130 according to an implementation of this document will be described in detail with reference to FIGS. 1 and 2.

FIGS. 20 to 22 are diagrams illustrating a detection unit according to a third implementation of this document.

In the implementation according to FIGS. 20 to 22, a method of fixing a sol-gel composition will be described. A description of the same process will be omitted.

Referring to FIG. 20, a hydrophilic layer 140 is positioned at an upper surface of the electrode 36, and the sol-gel compositions 100 to 130 are positioned at an upper surface of the hydrophilic layer 140.

As described above, the electrode 36 provides a function of transferring electrons generated in the detection material 104. The hydrophilic layer 140 is positioned at an upper surface of the electrode 36.

The hydrophilic layer 140 is coated at an upper surface of the electrode 36 with a micro array method and a screen printing method. The micro array may be coated with a spuit method. The screen printing may be coated with a mask method. The hydrophilic layer 140 may be the surface treatment film 330 described with reference to FIG. 7.

As the hydrophilic layer 140 is positioned at an upper surface of the electrode 36, index materials or enzyme binding antibodies 90 are prevented from non-specifically coupling to an upper surface of the electrode 36. For example, when the enzyme binding antibody 90 that is not coupled with an index material is non-specifically coupled to the electrode 36, an error signal regardless of an index material may occur. That is, the hydrophilic layer 140 can prevent an error signal induction material from coupling to the electrode 36.

Further, the hydrophilic layer 140 allows electrons generated in the sol-gel composition to easily transfer to the electrode 36. Specifically, when a detection reagent is provided to the sol-gel composition, electrons may be generated in the sol-gel composition. The generated electrons are comprised in the detection reagent to advance toward the hydrophilic layer 140. Because the hydrophilic layer 140 has a high affinity with the detection reagent, the hydrophilic layer 140 can transfer electrons comprised within the detection reagent to the electrode 36.

The hydrophilic layer 140 may be formed with, for example, polyvinyl alcohol (PVA).

The sol-gel compositions 100 to 130 are positioned at an upper surface of the hydrophilic layer 140.

The sol-gel compositions 100 to 130 are positioned at an upper surface of the hydrophilic layer 140 with the above-described micro array or spuit method. For example, the sol-gel compositions 100 to 130 are sprayed in the hydrophilic layer 140 in a sol state and formed in a gel state at an upper surface of the hydrophilic layer 140 and thus are fixed to the hydrophilic layer 140. Further, the sol-gel compositions 100 to 130 are coupled with an upper surface of the hydrophilic layer 140 in a gel state.

The sol-gel compositions 100 to 130 are stably coupled with the hydrophilic layer 140. For example, because the sol-gel compositions 100 to 130 are not coupled with a covalent bond, for example, a chemical reaction with the hydrophilic layer 140, stability of coupling is increased. Therefore, even if the sample or the detection reagent flows after passing through the gel compositions 100 to 130, the sample or the detection reagent is stably fixed to an upper surface of the hydrophilic layer 140 or the electrode 36.

The sol-gel compositions 100 to 130 are positioned at an upper surface of the electrode 36. That is, the sol-gel compositions 100 to 130 may be directly positioned at an upper surface of the electrode 36 without the hydrophilic layer 140.

The sol-gel compositions 100 to 130 enclose the detection material 104 in a three-dimensional capsule form. That is, as described above, a plurality of detection materials 104 are collected in one sol-gel compositions 100 to 130. Therefore, the sol-gel compositions 100 to 130 can increase a fixing amount of the detection material 104.

Further, because the sol-gel compositions 100 to 130 provide a three-dimensional structure, the sol-gel compositions 100 to 130 can provide high reactivity. That is, the sol-gel compositions 100 to 130 allow the first coupling material 90a and the detection material 104 to easily react. Referring to FIG. 20, an arrow shown in FIG. 20 illustrates a traveling direction of the first coupling material 90a. That is, the first coupling material 90a advances toward the sol-gel compositions 100 to 130 in various directions. The first coupling material 90a reacts with the detection material 104 through an air gap formed in the sol-gel compositions 100 to 130. Therefore, the sol-gel compositions 100 to 130 can increase reactivity of the first coupling material 90a and the detection material 104.

Particularly, the sol-gel compositions 110 and 130 increase an electron transfer ratio to the electrode 36. That is, electrons generated in the sol-gel compositions 110 and 130 are easily transferred to the electrode 36 by the gold particle 106.

Referring to FIG. 21, a polymer layer 142 is positioned at an upper surface of the electrode 36, and the sol-gel compositions 100 to 130 are positioned at the inside and/or the outside of the polymer layer 142.

The polymer layer 142 is positioned at an upper surface of the electrode 36. For example, the polymer layer 142 may be coated with a spin coating method. Here, the polymer layer 142 may be an example of the surface treatment film 330 described with reference to FIG. 76.

The polymer layer 142 is coated at an upper surface of the electrode 36 in a state mixed with the sol-gel compositions 100 to 130 of a sol or gel state.

The polymer layer 142 provides a function of stably fixing a plurality of sol-gel compositions 100 to 130 to an upper surface of the electrode 36.

The polymer layer 142 may be formed with various materials. That is, the sol-gel compositions 100 to 130 can use a material having an air gap that can be easily impregnated within a polymer.

Further, the sol-gel compositions 100 to 130 are positioned at the outside of the polymer layer 142. For example, after the polymer layer 142 is cured, by coating the sol-gel compositions 100 to 130 at the outside of the polymer layer 142, a fixing ratio of the sol-gel compositions 100 to 130 can be increased.

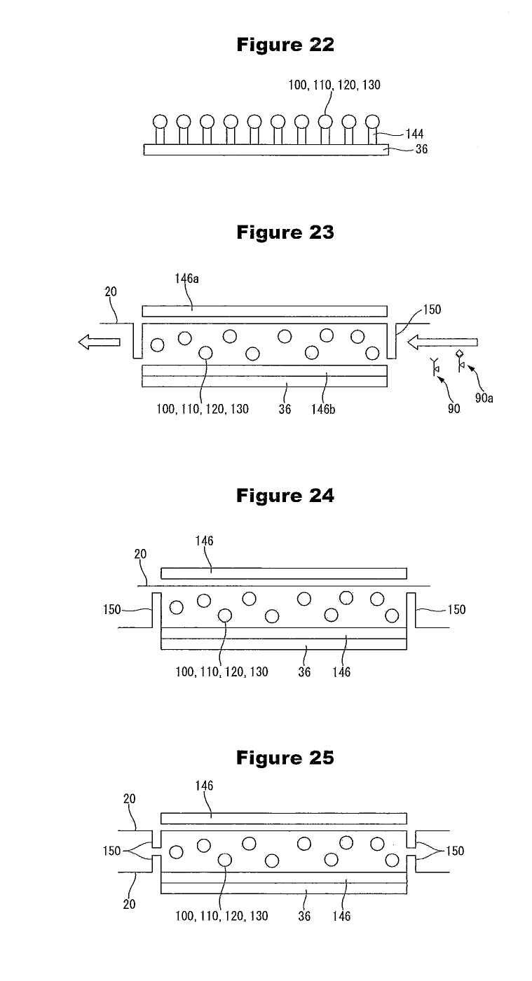

Referring to FIG. 22, a monomer layer 144 is positioned at an upper surface of the electrode 36, and the sol-gel compositions 100 to 130 are positioned at an upper surface of the monomer layer 144.

The monomer layer 144 may be fixed with an unknown method at an upper surface of the electrode 36.

The sol-gel compositions 100 to 130 are fixed by coupling with the monomer layer 144. That is, the sol-gel compositions 100 to 130 are conveniently fixed through the monomer layer 144.

FIGS. 23 to 25 are diagrams illustrating a detection unit according to a fourth implementation of this document.

In an implementation according to FIGS. 23 to 25, a sol-gel composition can be positioned between posts of both ends positioned at the detection unit.

The detection unit 30 comprises an electrode 36, a magnetic force portion 146, a post 150, and sol-gel compositions 100 to 130.

The post 150 is formed in the channel 20. The post 150 provides a function of staying the sol-gel compositions 100 to 130 on the electrode 36. That is, the sol-gel compositions 100 to 130 positioned on the electrode 36 may not pass through the post 150. For this reason, before and after the sample contacts with the electrode 36, the post 150 is disposed. The post 150 may be an example of an interception portion for intercepting movement of a sol-gel composition.

As shown in FIG. 23, a gap between the post 150 and the electrode 36 may be smaller than a minimum length of the sol-gel compositions 100 to 130. For example, when a size of the sol-gel compositions 100 to 130 is 200 nanometer (nm), a gap between the post 150 and the electrode 36 may be smaller than 200 nm. The post 150 may be an example of a latch jaw. Therefore, the post 150 can have any shape that can perform a function as a latch jaw of the gel compositions 100 to 130.

The post 150 is formed from the electrode 36. In this case, the post 150 may be formed with the same material as that of the electrode 36. The post 150 may be formed from the channel 20. In this case, the post 150 may be formed with the same material as that of the channel 20.

As shown in FIG. 24, the post 150 may be formed toward the channel 20 at which the electrode 36 is positioned.

Even in this case, the post 150 provides a function of reducing a flow area of the channel 20. That is, the post 150 prevents the sol-gel compositions 100 to 130 existing between the posts 150 of both ends from discharging to the outside of the post 150. For this reason, a length of the post 150 is determined in consideration of a shortest length of the sol-gel compositions 100 to 130.

Further, as shown in FIG. 25, the post 150 is protruded to face from the facing channel 20.

Although not shown, while the detection unit 30 prevents the sol-gel compositions 100 to 130 from being escaped, the detection unit 30 comprises all structures that can inject and/or discharge the sample. For example, the interception portion may have a shape comprising at least one hole. That is, the hole has a diameter smaller than a minimum diameter of the sol-gel compositions 100 to 130 and thus intercepts discharge of the sol-gel compositions 100 to 130. The hole may comprise a shape having at least one angle as well as a circular shape.

Referring to FIGS. 23 to 25, the magnetic force portion 146 can control a position of the sol-gel compositions 120 and 130. The magnetic force portion 146 can apply the forces of attraction and repulsion to the magnetic material 108 comprised in the sol-gel compositions 120 and 130 using a magnetic force.

For example, the magnetic force portion 146 may float the sol-gel compositions 120 and 130 from the electrode 36. By floating the sol-gel compositions 120 and 130 on the electrode 36, a reaction area with the first coupling material 90a can be increased.

Alternatively, the magnetic force portion 146 may apply the forces of attraction and repulsion to the sol-gel compositions 120 and 130 in order to attach the sol-gel compositions 120 and 130 to an upper surface of the electrode 36. In order to attach the sol-gel compositions 120 and 130 to the electrode 36, by applying the forces of attraction and repulsion to the sol-gel compositions 120 and 130, the magnetic force portion 146 prevents the sol-gel compositions 120 and 130 from being swept away by a washing liquid. Further, the magnetic force portion 146 allows electrons generated in the sol-gel compositions 120 and 130 to easily move to the electrode 36.

The magnetic force portion 146 can be positioned at various positions such as an upper part of the electrode 36 and an upper end of the channel 20. For example, a magnetic force portion 146a may be positioned at the inside and/or the outside of the channel 20. A magnetic force portion 146b can be positioned at an upper surface and/or a lower surface (not shown) of the electrode 36.

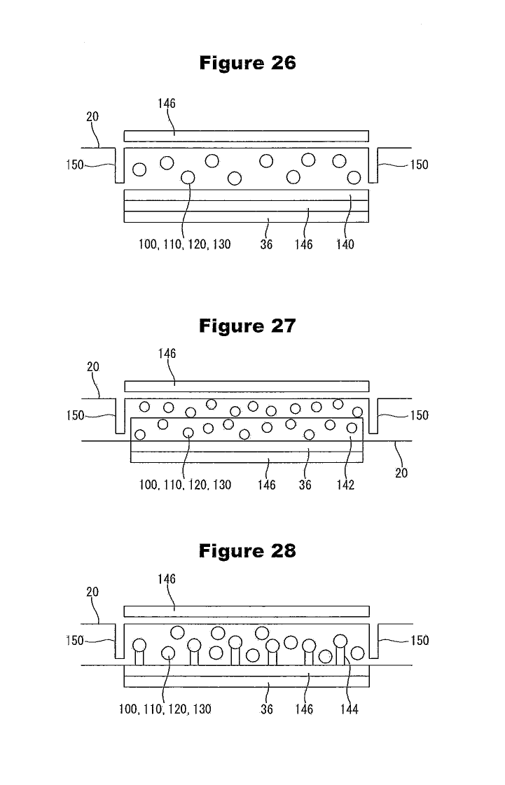

FIGS. 26 to 28 are diagrams illustrating a detection unit according to a fifth implementation of this document.

The detection unit according to an implementation of FIGS. 26 to 28 may be formed in various combinations of detection units according to implementations of FIG. 5 and FIG. 23. That is, implementations according to FIGS. 26 to 28 may overlappingly have an operational effect of each implementation.

As shown in FIG. 26, the detection unit 30 comprises a hydrophilic layer 140, a magnetic force portion 146, an electrode 36, a post 150, and sol-gel compositions 100 to 130. By adding the hydrophilic layer 140 to an implementation according to FIG. 23, non-specific coupling is prevented and an electron transfer ratio can be increased.

As shown above, the hydrophilic layer 140 may be positioned at an upper surface of the magnetic force portion 146, and although not shown, the hydrophilic layer 140 may be positioned between the magnetic force portion 146 and the electrode 36.

As shown in FIG. 27, the detection unit 30 may further comprise the polymer layer 142 of an implementation according to FIG. 21 in an implementation described with reference to FIG. 23.

As shown in FIG. 28, the detection unit 30 may further comprise the monomer layer 144 of an implementation according to FIG. 22 in an implementation described with reference to FIG. 23.

Further, although not shown, all the hydrophilic layer 140, the polymer layer 142, and the monomer layer 144 may be added to a configuration of an implementation according to FIG. 23. Various combinations of other elements can be obtained.

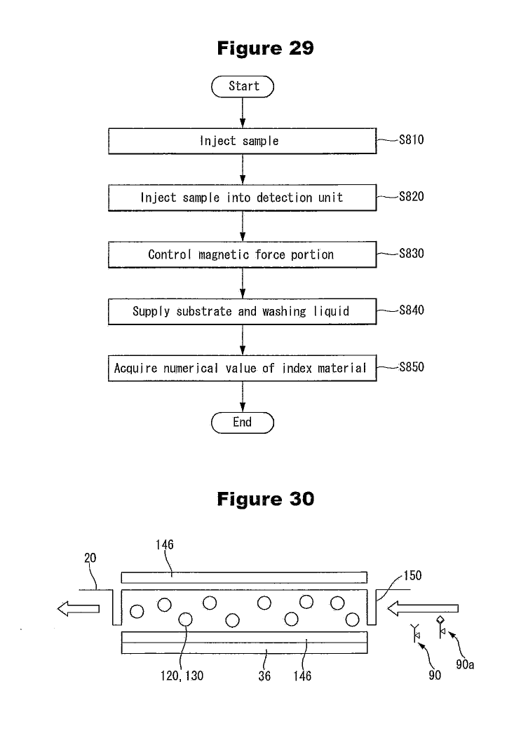

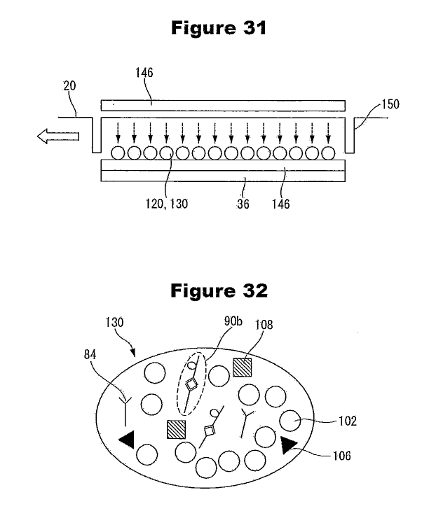

FIG. 29 is a flowchart illustrating a method of controlling a sol-gel composition according to an implementation of this document, and FIGS. 30 and 31 are diagrams illustrating movement of a sol-gel composition according to an implementation of this document. FIG. 32 is an enlarged view illustrating a sol-gel composition. The following order is a random order and may be variously combined and executed according to necessity of a person of ordinary skill in the art.

A sample is injected through the inlet 10 (S810).

As described above, the sample may comprise an index material to detect. In the present implementation, for convenience of description, a method of detecting an index material may be described by an antigen-antibody reaction.

The sample injected through the inlet 10 is moved to the storage 34 through the channel 20. The enzyme binding antibody 90 stored at the storage 34 is coupled with an index material to form the first coupling material 90a.

The formed first coupling material 90a is injected into the detection unit 30 (S820).

The controller 270 detects whether the first coupling material 90a is injected into the detection unit 30 through, for example, a scattering angle and scattering intensity of scattering light formed in the detection unit 30.

When the sample is injected into the detection unit 30, the controller 270 applies a magnetic force to the sol-gel compositions 120 and 130. For example, the controller 270 may apply a magnetic force to the detection unit 30 through the magnetic force portion 146.

As shown in FIG. 30, the controller 270 controls the sol-gel compositions 120 and 130 to float at a predetermined height. As described above, because a reaction area of the first coupling material 90a and the sol-gel compositions 120 and 130 can increase, a reaction ratio can be increased.

FIG. 32 illustrates a state in which the first coupling material 90a and the fixing antibody 84 of the sol-gel composition 130 are coupled. That is, a plurality of fixing antibodies 84 comprised in the sol-gel composition 130 form a second coupling material 90b by coupling with the first coupling material 90a.

The controller 270 applies a magnetic force in an electrode direction through the magnetic force portion (S830).

After a predetermined time period for generating the second coupling material 90b has elapsed, the controller 270 applies a magnetic force to the sol-gel compositions 120 and 130. As shown in FIG. 31, the controller 270 applies a magnetic force so that the sol-gel compositions 120 and 130 close contact with an upper surface of the electrode 36 through the magnetic force portion 146. A dotted line of FIG. 31 illustrates a direction of a magnetic force. As the sol-gel compositions 120 and 130 are attached to the electrode 36, a transfer ratio of transferring generated electrons to the electrode 36 can be increased.

The controller 270 supplies a substrate and a washing liquid to the detection unit 30 (S840).

The washing liquid removes a foreign substance existing in the detection unit 30. The foreign substance indicates all materials regardless of detection of an index material. For example, a material related to detection of an index material may be the first coupling material 90a. Further, a material regardless of detection of an index material may be an enzyme binding material 90 and a blood corpuscle material.

The sol-gel compositions 100 to 130 may not be swept away by a washing liquid by a post. That is, because a gap between the post 150 and the electrode 36 is smaller than a size of the sol-gel compositions 100 to 130, the sol-gel compositions 100 to 130 may not be swept away by a washing liquid and remain within an area of the electrode 36.

Particularly, the sol-gel compositions 120 and 130 can be attached to an upper surface of the electrode 36 by magnetism of an electrode direction of the magnetic force portion 146 and thus may not be swept away by a washing solution.

The substrate generates electrons by reacting with the second coupling material 90b. That is, the substrate generates electrons by performing a chemical reaction with the second coupling material 90b comprised in the sol-gel compositions 100 to 130. A detailed mechanism thereof has been described in the above-described description.

The generated electrons advance toward the electrode 36. For example, the generated electrons are comprised in a substrate aqueous solution to advance toward the electrode 36. In this case, the magnetic force portion 146 is disposed not to disturb flow of a substrate aqueous solution. Further, the magnetic force portion 146 is formed in a spot form in order to do not disturb flow of a substrate aqueous solution.

Particularly, the hydrophilic layer 140 (see FIG. 20) positioned at an upper surface of the electrode 36 can increase a transfer ratio of a substrate aqueous solution, particularly, electrons to the electrode 36.

The controller 270 acquires a numerical value of an index material (S850).

The controller 270 detects electrons generated from the detection unit 30. For example, the controller 270 may detect a voltage or a current of generated electrons through the first connection portion 40, the second connection portion 210, and the analyzing unit 220.

The analyzing unit 220 makes a quantity or a density of an index material in a numerical value based on a generated voltage or current.

Further, the controller 270 outputs a quantity or density of an index material through the display unit 230.

Further, the controller 270 transmits a quantity or density of an index material to a corresponding institution through the communication unit 240. For example, the controller 270 may transmit a quantity or density of an index material to a medical institution, an environment institution, and a guardian.

Various implementations described in this document may be executed individually or in combination. Further, steps constituting each implementation may be combined with steps constituting other implementations and executed.

For example, detection units according to first to fifth implementations of this document may be combined.

According to a cartridge of this document, by increasing the number of reaction individuals, allowing a detection signal to occur regardless of a direction of reaction individuals, a detection signal is amplified and storability of the cartridge is improved.

According to this document, electron generation can be maximized and an electron transfer ratio can be increased through a position control of a sol-gel composition.

According to this document, a sol-gel composition can be stably fixed.

According to this document, an error signal can be reduced.

Although implementations of this document have been described in detail hereinabove, it should be clearly understood that many variations and modifications of the basic inventive concepts herein described, which may appear to those skilled in the art, will still fall within the spirit and scope of the implementations of this document as defined in the appended claims.

What is claimed is:

1. A cartridge comprising:
a channel configured to provide a flow passage of a sample;
an electrode positioned at a specific segment of the channel;
a fixing structure positioned at the specific segment; and
a detection material coupled to a surface of the fixing structure to detect an index material,
wherein a surface area of the fixing structure at the specific segment is larger than that of the electrode at the specific segment.

2. The cartridge of claim 1, wherein one surface of the electrode is coated with at least one of a hydrophilic monomer and a hydrophilic polymer.

3. The cartridge of claim 1, wherein the fixing structure is coated with at least one of bovine serum albumin (BSA) and casein.

4. The cartridge of claim 1, further comprising a filter portion configured to remove an error signal induction material comprised in the sample.

5. The cartridge of claim 1, wherein the fixing structure comprises at least one post.

6. A cartridge comprising:
a channel configured to provide a flow passage of a sample;
an electrode positioned at one side of the channel;
a hydrophobic membrane positioned at a flow passage on the electrode; and
a detection material impregnated to the hydrophobic membrane configured to detect an index material.

7. The cartridge of claim 6, wherein the hydrophobic membrane is polyvinylidene fluoride.

8. The cartridge of claim 6, wherein the hydrophobic membrane is coated with at least one of BSA and casein.

9. The cartridge of claim 6, wherein the hydrophobic membrane has porosity.

10. A cartridge comprising:
an electrode; and
a sol-gel composition comprising a detection material positioned on the electrode to detect an index material.

11. The cartridge of claim 10, further comprising a hydrophilic layer provided on the electrode,
wherein the sol-gel composition is provided on the hydrophilic layer.

12. The cartridge of claim 11, wherein the hydrophilic layer comprises a hydrophilic polymer layer or a hydrophilic monomer layer.

13. The cartridge of claim 10, further comprising:
a channel at which the electrode is provided and for providing a flow passage of the index material; and
an interception portion positioned at both ends of the electrode with the electrode positioned therebetween and for reducing a flow passage of the index material,
wherein the sol-gel composition is positioned between the interception portion.

14. The cartridge of claim 13, wherein the interception portion narrows the flow passage in order for the sol-gel composition to prevent to pass through the reduced flow passage.

15. The cartridge of claim 10, wherein the sol-gel composition comprises a gold particle.

16. The cartridge of claim 10, wherein the sol-gel composition comprises a magnetic material.

17. The cartridge of claim 16, further comprising a magnetic force portion for controlling a position of the sol-gel composition by applying a magnetic force to the magnetic material.
